(19) United States
(12) Patent Application Publication
(10) Pub. No.: US 2009/0125377 A1
(43) Pub. Date: May 14, 2009

(54) PROFILING SYSTEM FOR ONLINE MARKETPLACE

(75) Inventors: Shiraz M. Somji, Kenmore, WA (US); Aditya Ghuwalewala, Kirkland, WA (US); Matthew J. Fleckenstein, Seattle, WA (US); Shilpa Agarwal, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/939,796

(22) Filed: Nov. 14, 2007

(51) Int. Cl. G06F 17/40

(52) U.S. Cl. 705/10

(57) ABSTRACT

A profiling system provides customized, relevant, and targeted experience to customers of its clients throughout various touch points in an online marketplace. The profiling system utilizes gathered data on customers such as online marketplace behavior, subscriber information, usage, and the like to determine relevant segments for the customers. The segments are created and modified based on default and/or client defined rules. Intersections of these elements are used to classify subscribers of the marketplace into the segments on a periodic basis. Customized content such as tailored advertisements, engagement messages, customer relations communication, etc., are then provided to the subscribers based on the segments.

### BACKGROUND

Online services have become common tools for sales and marketing for businesses and other organizations. Some businesses also utilize automated information systems to help automate sales and sales force management functions. A sales force automation system typically includes a contact management system, which tracks contacts established with existing and new customers; a sales lead system, which lists potential customers; an order tracking system; a forecasting system; and other components such as product knowledge.

On the marketing side, marketing personnel typically receive information from the sales side and utilize different marketing tools to generate strategies for marketing based on information collected through sales operations and other avenues. Small businesses, in particular, use a wide variety of sales and marketing services that are commonly not well integrated. For example, they might have a web site, purchase keywords from internet search engines, keep a list of customers, send email or direct mail to the customers, track the success of various efforts, etc.

For marketing campaigns to be successful, targeted approach to potential customers is crucial. Online marketplaces are visited by numerous potential customers who purchase, inquire, or simply view products and services. Thus, it would be a very valuable tool for a company to be able to have background information in a meaningful manner about these existing and potential customers.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to a profiling system for an online community that is capable of creating rules-based segments of community subscribers and provide updated information on subscriber segments for a relevant and targeted experience to clients. The segment information may be used for targeted content such as tailored advertisements, engagement messages, customer relationship management (CRM) communications, and the like.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a conceptual diagram illustrating a profiling system with its peripheral components and interactions;

FIG. 2 illustrates major components of the architecture of a profiling system;

FIG. 3 illustrates an example profiling web service and its interactions with components of an online community;

FIG. 4 illustrates a logic overview of a profile database as part of a profiling system according to embodiments;

FIG. 5 is a networked environment where an automated sales and marketing system according to embodiments may be implemented;

FIG. 6 is a block diagram of an example computing operating environment, where embodiments may be implemented; and

FIG. 7 illustrates a logic flow diagram of an example process of providing a profiling service in a system according to embodiments.

### DETAILED DESCRIPTION

As briefly described above, various online targeted content delivery activities may be enhanced by providing clients subscriber segment information through a dynamic and comprehensive profiling system that can create and modify segments based on default and/or client defined rules. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process.

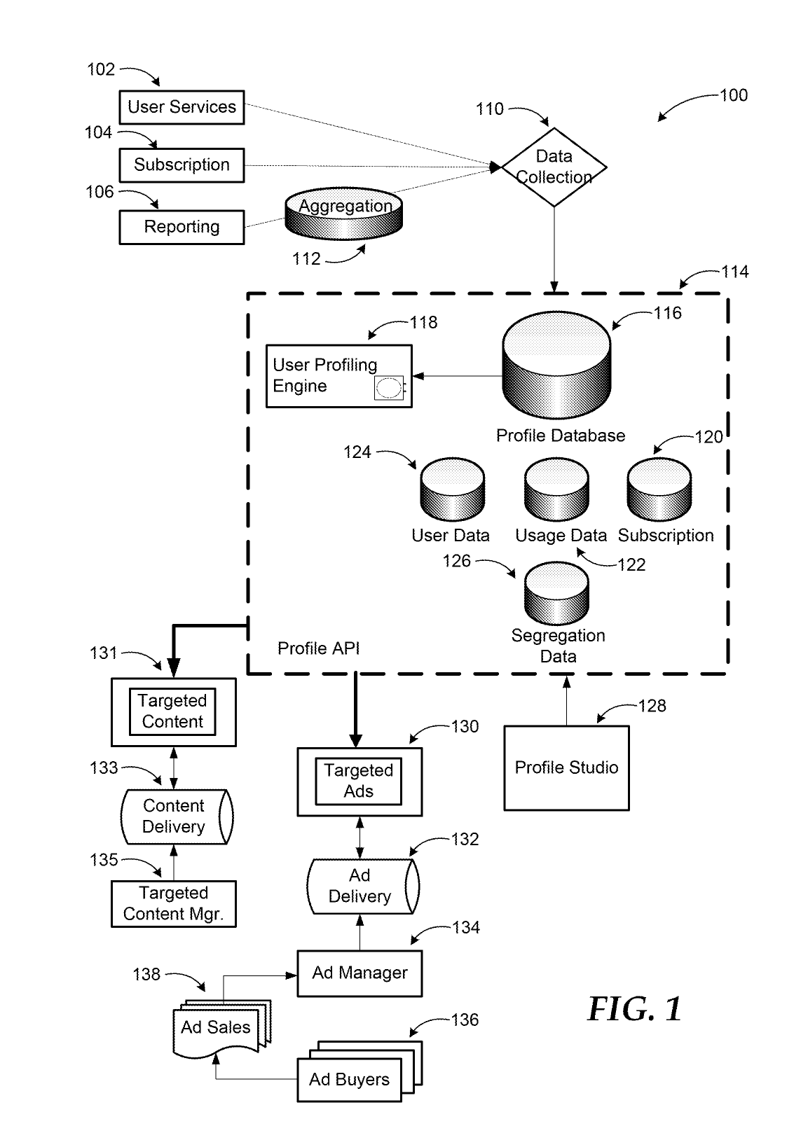

Referring to FIG. 1, a conceptual diagram of a profiling system with its peripheral components and interactions is illustrated. Such a system may be implemented as a local application with communication capabilities through a number of networks, a distributed application over a number of computing devices, or as a hosted service integrating a suite of applications with subscribers taking advantage of various features.

Systems and methods according to embodiments may be implemented in any online community such as an online marketplace, social networks, an enterprise community, and the like. Throughout this disclosure references are made to online marketplace and other types of online communities as example embodiments. It should be noted that a profiling system as disclosed herein may be implemented in any online community (comprising one or more websites and networks) using the principles discussed.

In an online marketplace, success of marketing activities such as advertising campaigns depends on gathering relevant and useful marketing research data such as demographic, psychographic, behavioral, product acceptance, product problems, detecting trends, and the like. Such data may come from numerous resources such as analyzing sales trends, customer and/or potential customer inquiries, post-sales follow-ups, general market trends, and the like. Parameters in determining marketing strategies and organizing campaigns may include identifying profitable customers, tracking productivity of sales approaches and advertising based on revenue per sales person, revenue per territory, margin by, margin by customer segment, margin by customer, number of calls per day, time spent per contact, revenue per call, cost per call, entertainment cost per call, ratio of orders to calls, revenue as a percentage of sales quota, number of new customers per period, number of lost customers per period, cost of customer acquisition as a percentage of expected lifetime value of customer, percentage of goods returned, number of customer complaints, and the like.

From a marketing perspective, online tools for designing and executing marketing strategies may be enabled to identify segments within a target market and valuable customers, to develop profiles (demographic, psychographic, and behavioral) of core customers, understand strengths and weaknesses of past and current campaigns, and to modify marketing strategies for the products using the marketing mix variables of price, product, distribution, and promotion. This way, a sustainable competitive advantage may be created. According to some embodiments, a profiling system provides a customized, relevant and targeted experience to its customers throughout various touch points in the online marketplace. The profiling system utilizes innovative techniques to build an all pervasive view of each subscriber and provides the flexibility to create complex rules based segments. The system may use the intersection of these elements to classify its subscribers into the segments on a periodic (e.g. daily) basis. These segments may then be used to tailor advertisements, engagement messages, CRM emails, and the like to the marketplace subscribers, to promote active users, and achieve high customer satisfaction.

A profiling system according to embodiments may use many vectors to collect information about its subscribers. These vectors include information collected at sign-up to the marketplace as well as information provided at access credential creation time (subscription service 104). Once a customer becomes a marketplace subscriber, he/she may interact with the marketplace in many ways. The activities of interest for profiling purposes include additional purchases, the use of consumables such as email accounts, disk storage, email marketing messages, and key word purchases for search engine marketing (user services 102). In addition to these subscription related activities, the profiling system may track a customer's page views. The page views are an integral part of the profiling system and they may be tracked by the system or through a third party reporting tool (reporting service 106). These page views provide an insightful view into the customer's activities in the online marketplace and form a core vector of the profiling system. The reporting service reports may be aggregated (112) before being provided to data collection 110 along with other vectors. It should be noted, that a profiling system according to embodiments is an extendable and scalable system and may include fewer or additional vectors configured according to default or customer defined rules. The vectors may also be processed dynamically based on customer preferences. For example, certain vectors may be utilized at particular times (e.g. holiday shopping season).

The data collected periodically through various feeds is provided to profiling system through profile application programming interface (API) 114 and stored in one or more data ware houses. The feeds may come from both external and internal systems and may be coupled with relevant authentication and authorization mechanisms. The main data store for the collected data is profiling database 116, which may include sub-components such as user data store 124, usage data store 122, and subscription data store 120. The sub-components may also be external data stores that are accessed by the system as needed. The collected data may be mined for consistency and accuracy. A specialized module may then transform the data into a consumable format and reclassify affected users into relevant segments. User profiling engine 118 may perform one or more of these tasks within the profiling system such as delivering mined data from a data warehouse to the profile database 116.

Profiling studio 128 may be used by marketing managers to create and tailor the segment definitions. The rules for creating and customizing segments may range in complexity and be dictated by business needs. Profiling studio 128 may assist marketing managers through this process by providing a simplified user experience and a sample of the population that will be affected by the segment in question. Since a user can be classified into multiple segments and some of these segments may compete for a portion of the online marketplace, the profiling studio 128 may allow the marketing managers to assign priorities to these segments. The profiling system may consider these priorities as it responds to calls from systems that display targeted content 131 to users.

Profiling studio 128 is essentially a combination of administration tool consoles of the profiling service that empower clients to utilize the profiling infrastructure for targeting online marketplace users. Profiling studio 128 may comprise a profile campaign console for enabling marketing managers to manage campaigns, an administration console for prioritizing and activating campaigns, and a view console for providing user information to the client such as identifier(s).

A system according to embodiments enables marketing managers to run more than one campaign at the same time by ranking the campaigns based on a priority assigned to each campaign. A higher priority indicates an increased likelihood for a user to be targeted by that campaign. This way the marketing team can change the priority whenever they want and start a different campaign targeting the users based on their profile.

Profiling studio 128 may also be used by marketing managers to create and launch campaigns. A campaign is basically a set of profile groups which are targeted with the same message. The marketing teams manage campaigns (set dates to run them, prioritize them, etc.) and the profiling system in turn applies the campaign dates and priorities to the profile groups that are associated with a particular campaign. Campaigns provide an easy way for marketing teams to organize and target more than one profile group. A new profile group may be added to an existing campaign and an existing profile group can be removed or disabled from a campaign as needed providing marketing with more flexibility to target the users.

Targeted content 131 may be managed by targeted content manager 135 based on input from the profiling system and delivered through targeted content delivery 133. The targeted content 131 may include engagement messages that are profiled, CRM messages, and other advertising material. A significant example of targeted content is targeted advertising 130, which may be provided to an advertising delivery service 132 (which may be an internal or external service), where advertising manager 134 manages advertising sales 138 to advertising buyers 136. The profiling system may further provide documented interfaces for third party providers to incorporate their services to the profiling service.

Embodiments described herein refer to applications and/or modules such as those discussed above, but they are not limited to specific applications. Any application or hosted service that performs subscriber profiling tasks in a networked environment may be integrated into a profiling system using the principles described herein. While the Internet is mentioned for example systems, systems according to embodiments may also utilize private networks, and other communication means.

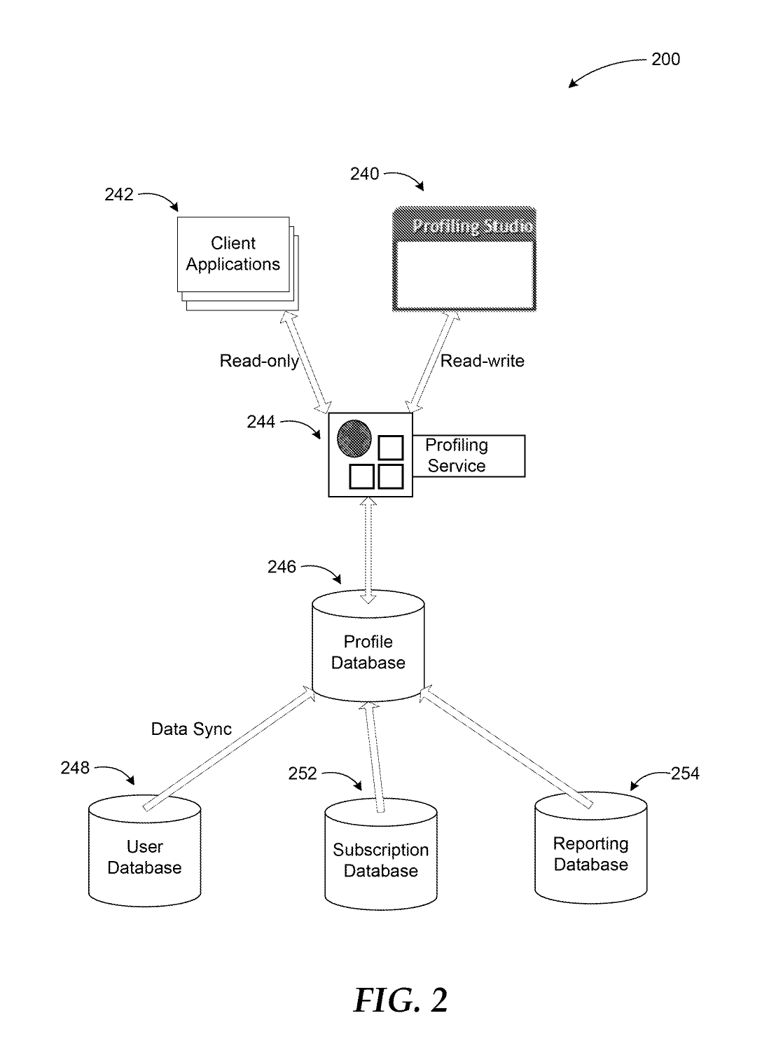

FIG. 2 illustrates major components of the architecture of a profiling system. While major components corresponding to core functionalities of a profiling system are shown in diagram 200, these functionalities may of course be executed by additional or fewer components.

At the core of a profiling system is profiling service 244 (including a web service, an API, etc.), which enables interaction between clients of the service and the profile database. Client applications 242 make a call to profiling service 244 when a user logs in to the online marketplace providing the user's identifier and the client's identifier (the client using the profiling service). Ultimately, the profiling service 244 may return an appropriate profile group for the user to client application(s) 242 such that the client application can provide relevant content to the user. The identification scheme may be a more elaborate scheme utilizing an anonymous identifier, a subscription identifier, and the user identifier. Cookies may be used to keep track of provided identifiers and assign the user to relevant segments as defined by the default and/or client provided rules.

Profiling studio 240, as discussed above, manages profile groups defined by the profiling service 244 and creates/updates rules for the profile groups defining attributes of these groups. Thus, there is a two-way communication between profiling studio 240 and profiling service 244 exchanging profile group definitions and the like. Profile database 246 stores specific information for profiling users and exchanges information with other data stores (data synching) such as user database 248, subscription database 252, and reporting database 254.

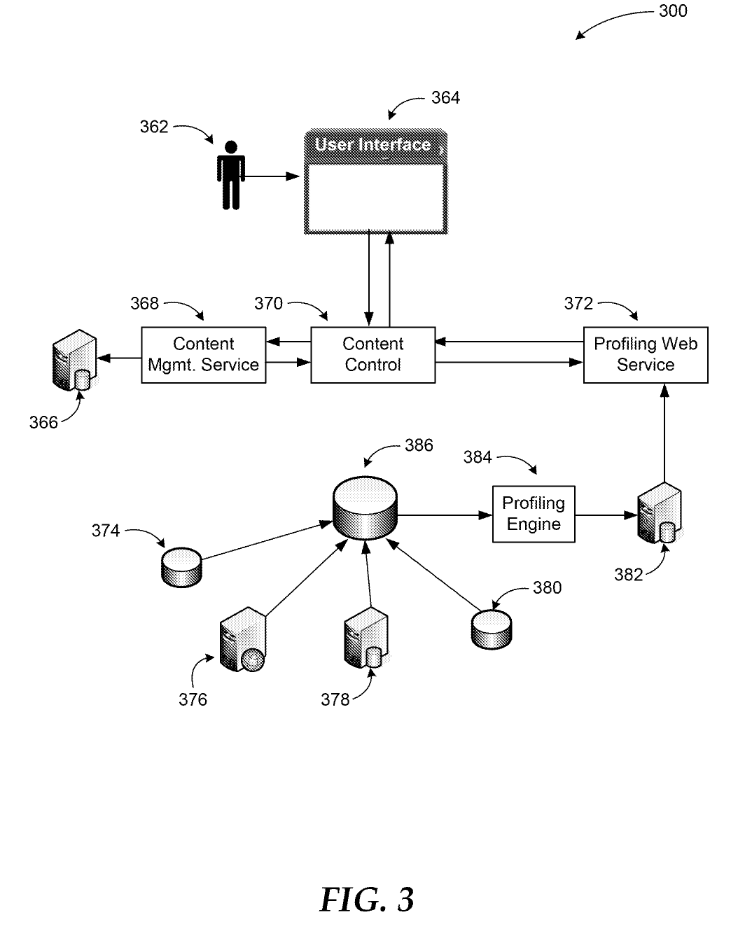

FIG. 3 illustrates an example profiling web service and its interactions with components of an online community. Diagram 300 includes example components and interactions for a web based marketplace with content management and profiling services. Services and systems described herein are not limited to web based entities, however. As mentioned above, a profiling system according to embodiments may be implemented in marketplace restricted to private networks (e.g. an enterprise network) or other ways. Moreover, such systems and marketplaces may be implemented with additional or fewer components that interact in additional ways than those described in the figure. Businesses and/or organizations utilizing a profiling system may provide goods, services, or both.

User 362 participates in the online marketplace through a user interface of client application 364 by logging in to the marketplace, of which he/she is a subscriber. In an online marketplace that incorporates a profiling system according to embodiments, one aspect of the user interface initiates content control through content control module/application 370. This may entail providing user identifier(s), enabling the service to activate controls in the user's client application, and so on.

Content control module/application 370 provides users identifier(s) (e.g. anonymous identifier, subscription identifier, etc.) and other information such as user's locale, area, location, and the like, to profiling service 372. Profiling service 372 interacts with profiling database 382, which stores specific information for profiling users into rule based segments. Profiling engine 384 gathers collected data from various data stores (e.g. behavioral data store 374, user services data store 376, subscription data store 378, and segregation data store 380) into reporting data warehouse 386. Profiling engine 384 may also perform tasks such as computing page views for particular applications, defining data duration, and the like. Some of the data stores are represented as database servers, while others are shown as databases in the figure. This is to illustrate the diversity of data collection and storage techniques that may be employed in association with the profiling system.

Based on the user specific information and profile group information from profiling database 382, profiling service 372 determines one or more profile groups (segments) for the user (362) and provides that information to content control module/application 370. Content control module/application 370 provides the profile group information for the user (as well as locale, area, location information) to content management service 368, which manages content stored in one or more data stores such as content data store 366.

Content management service 368 determines relevant content to be provided to the user and returns that to content control module/application 370. The targeted content is then delivered to client application 364 for rendering in the user interface. Targeted content may include targeted advertising, customized messages, alerts, and other information customized for user 362. An important aspect of a system according to embodiments is that it provides profiling control and enables the content control module not only to bring profiled content, but also to provide profiled advertisement, profiled CRM messages, and the like.

Embodiments are not limited to the example components and interaction architecture provided in this figure. A web based profiling system as part of an online marketplace may be implemented with a number of additional components and functionalities depending on the needs of participating businesses and users (subscribers). Furthermore, the components may be implemented in a scalable and customizable architecture that includes documented interfaces such that users and/or profiling system clients can further integrate third party modules for added functionality.

By employing a profiling system according to embodiments as part of an online marketplace, personalization of subscribers' online experience is enabled. Moreover, profiles may be exchanged with partners of the online marketplace to extend relevant experience to the users when they access partner websites. Marketing campaigns may also be executed more with improved success through the use of targeted segments based on accurate and dynamic user profiles.

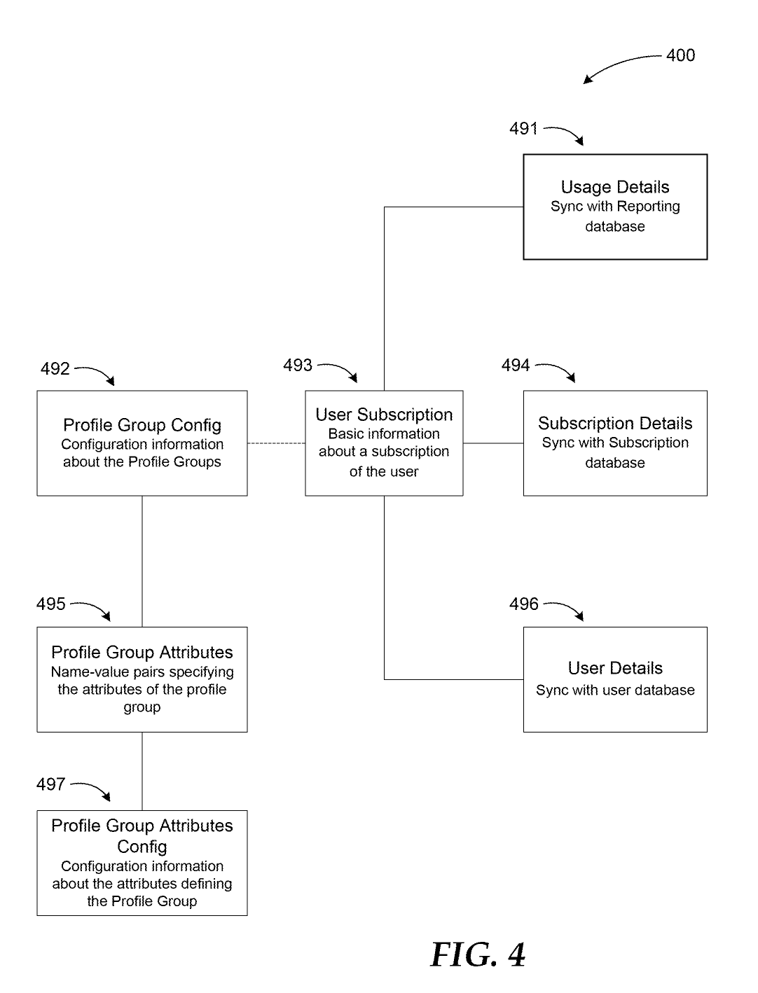

FIG. 4 illustrates diagram 400 of a logic overview of a profile database as part of a profiling system according to embodiments. A profile database may be implemented as one or more data stores that can exchange (and synchronize) relevant data with external data stores. It should be noted that FIG. 4 is not a detailed schema of the profiling database. Rather, it is intended to explain how main parts of the database are logically related to each other.

One part of the information stored in the profiling database is user subscription information 493, which includes basic information about subscription of the user such as user identifier(s). This information may be synchronized with information stored in other databases (internal or external) such as usage details information 491 in reporting database, subscription details information 494 in subscription database, and user details information 496 in user database. Through synchronizing the basic user information in the profiling database with other databases, additional relevant information about the users and their behavior may be retrieved from the other databases.

Profiling database may also include profile group configuration information 492, which may be associated with profile group attributes 495. Profile group attributes 495 may include name value pairs specifying the attributes of each profile group. Another portion of the profiling database may include profile group attributes configuration 497 for configuration information about the attributes defining each profile group.

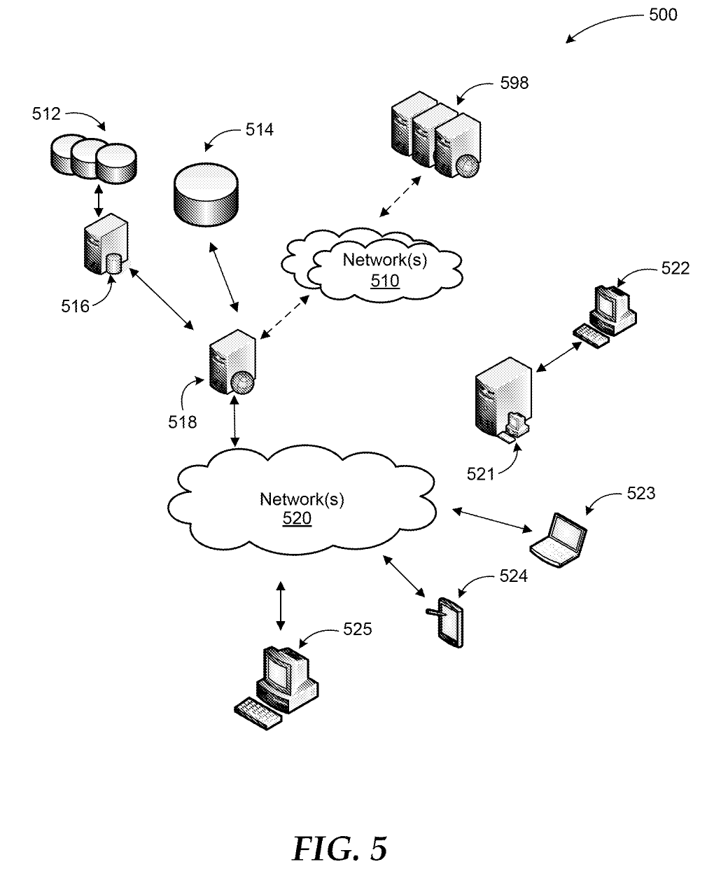

FIG. 5 is an example networked environment, where embodiments may be implemented. An online community incorporating a profiling system may be implemented employing local or distributed applications running on one or more computing devices configured in a distributed manner over a number of physical and virtual clients and servers. It may also be implemented in un-clustered systems or clustered systems employing a number of nodes communicating over one or more networks (e.g. network(s) 520 and 510).

Such a system may comprise any topology of servers, clients, Internet service providers, and communication media. Also, the system may have a static or dynamic topology, where the roles of servers and clients within the system's hierarchy and their interrelations may be defined statically by an administrator or dynamically based on availability of devices, load balancing, and the like. The term “client” as used in this portion may refer to a client application or a client device (the term has been used previously to refer to clients of the profiling service who provide targeted content to users of the online marketplace based on segmentation of the users through profiling). While a networked system implementing profiling system in an online community may involve many more components, relevant ones are discussed in conjunction with this figure.

As mentioned above, an online community may be implemented over network(s) 510 and accessed by subscribers using client devices or applications 523 through 525. Subscribers may also access the community through managed client devices such as client device 522 managed by server 521. A profiling system enabling participants to provide targeted content to the subscribers may be implemented in server 518 and interact with one or more data stores (e.g. profiling database) such as data store 514 or data stores 512 through database server 516. Profiling system may also interact with other services/applications such as those for gathering user information (behavioral, etc.). Such services and/or applications may reside on other servers and communicate with server 518 through network(s) 520 or through separate network(s) 510, which may be secure or private network inaccessible to other users of the online marketplace.

Network(s) 520 (and 510) may include a secure network such as an enterprise network, an unsecure network such as a wireless open network, or the Internet. Network(s) 520 and 510 provide communication between the nodes described herein. By way of example, and not limitation, network(s) 520 and 510 may include wired media such as a wired network or direct-wired connection, and wireless media such as acoustic, RF, infrared and other wireless media.

Many other configurations of computing devices, applications, data sources, data distribution systems may be employed to implement a profiling system. Furthermore, the networked environments discussed in FIG. 5 are for illustration purposes only. Embodiments are not limited to the example applications, modules, or processes.

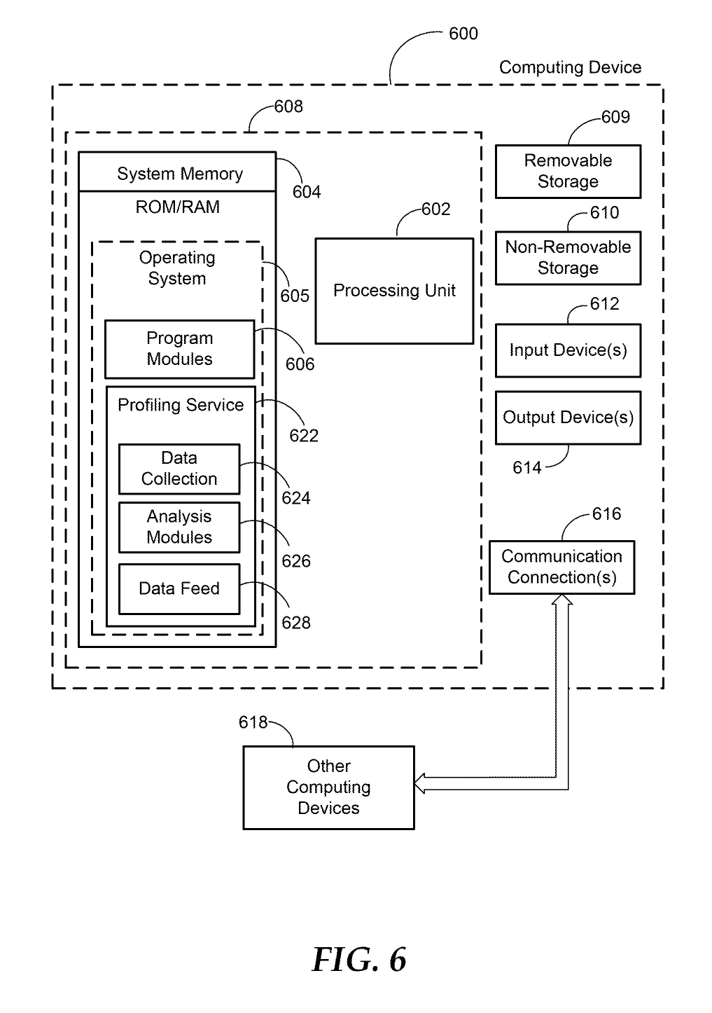

FIG. 6 and the associated discussion are intended to provide a brief, general description of a suitable computing environment in which embodiments may be implemented. With reference to FIG. 6, a block diagram of an example computing operating environment is illustrated, such as computing device 600. In a basic configuration, the computing device 600 may be a server managing the profiling service. Computing device 600 may typically include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of a networked personal computer, such as the WINDOWS® operating systems from MICROSOFT CORPORATION of Redmond, Wash. The system memory 604 may also include one or more software applications such as program modules 606, profiling service 622, data collection modules 624, analysis modules 626, and data feed modules 628.

Profiling service 622 may be an application or hosted service providing rule based segmentation of online community users according to their profiles to business clients. Data collection modules 622 may include any module or application that gathers (and mines) user profile data from various resources and profile group data from clients of the profiling service. Analysis modules 626 may include one or more modules (or applications) that perform analysis on collected user information for assigning users to relevant segments such that targeted and relevant content can be provided to the users. Data feed modules 628 provide profile group information and user information to a content management service/application for providing and rendering of targeted content for the user. This basic configuration is illustrated in FIG. 6 by those components within dashed line 608. The functionality of profiling service 622 does not have to be assigned to the distinct modules as described here. The above disclosed functionality may be performed by more or fewer modules or all by the same application (or service).

The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 612 such as keyboard, mouse, pen, voice input device, touch input device, etc. Output device(s) 614 such as a display, speakers, printer, etc. may also be included. These devices are well known in the art and need not be discussed at length here.

The computing device 600 may also contain communication connections 616 that allow the device to communicate with other computing devices 618, such as over a wireless network in a distributed computing environment, for example, an intranet or the Internet. Other computing devices 618 may include web servers, database servers, file servers, provider servers, and the like. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The claimed subject matter also includes methods of operation. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

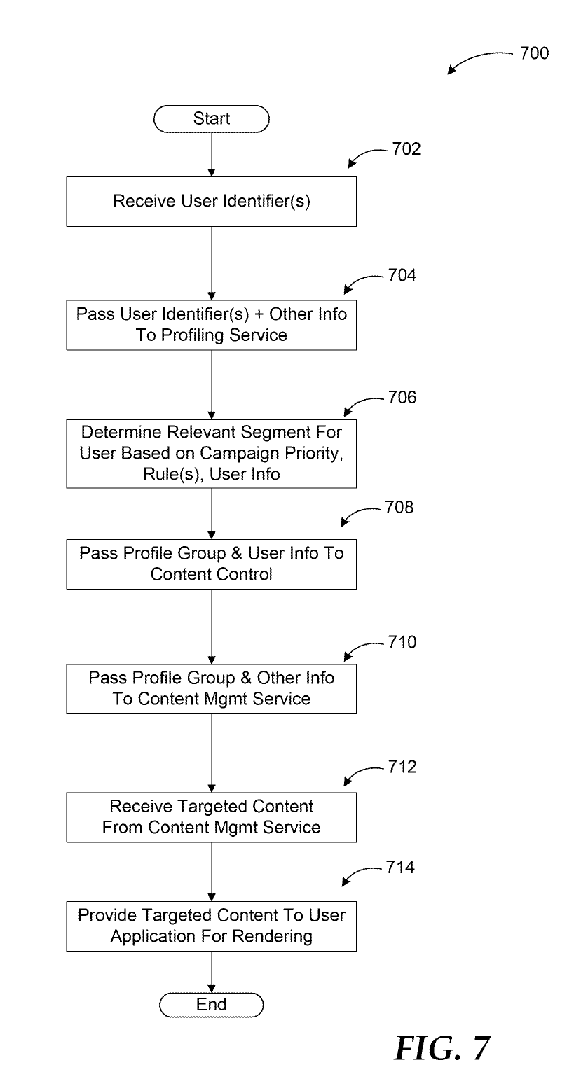

FIG. 7 illustrates a logic flow diagram of example process 700 of providing a profiling service in a system according to embodiments. Process 700 may be implemented in any networked environment. Process 600 may be implemented as part of an online marketplace incorporating a profiling service.

Process 700 begins with operation 702, where user identifier(s) are received at a content control module or application. As discussed before, an elaborate scheme may be implemented for ensuring anonymity and/or security of the user in the identification process. Processing continues to operation 704 from operation 702.

At operation 704, the received user identifier(s) and other information is passed to the profiling service. Other information may include information associated with the user's locale, area, location, and the like. Processing moves to operation 706 from operation 704.

At operation 706, a relevant segment is determined for the user based on a priority of campaigns, client defined (or default) rules, and user information gathered from different sources such as usage information, behavioral information, subscriber information, and so on, as well as profile group attributes. The segmentation may be performed based on default and/or client defined rules in a dynamic manner. Processing moves from operation 706 to operation 708.

At operation 708, the assigned profile group information and user information is passed back to the content control. A user may be assigned to one or more profile groups. Processing advances from operation 708 to operation 710.

At operation 710, the profile group and user information including the other information associated with the user's locale, area, location, and the like, are passed to a content management service which can retrieve targeted content for the user based on the assigned profile grouping. Processing moves from operation 710 to operation 712.

At operation 712, the targeted content is received from the content management service. Processing continues to operation 714 from operation 712, where the targeted content is provided to the user's application for rendering as part of the marketing campaign of the profiling system client. After operation 714, processing moves to a calling process for further actions.

The operations included in process 700 are for illustration purposes. An online marketplace incorporating profiling system may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing targeted content to subscribers of an online community through a profiling system, the method comprising:
receiving a subscriber identifier and location information associated with a subscriber;
receiving at least one rule for creating a subscriber segment;
retrieving subscriber information based on the subscriber identifier;
determining at least one subscriber segment for the subscriber based on a campaign priority, the location information, the subscriber information, and the at least one rule for creating the subscriber segment;
enabling retrieval of targeted content for the subscriber based on the at least one subscriber segment for the subscriber; and
enabling provision of the retrieved targeted content to an application for rendering to the subscriber.

2. The method of claim 1, wherein the subscriber information includes information collected about the subscriber through at least one from a set of: sign-up to the online community, log in to the online community, usage of services at the online community, and behavioral information, and wherein the location information includes at least one from a set of: subscriber locale, subscriber area, and subscriber location.

3. The method of claim 1, further comprising:
enabling a client associated with the targeted content to define and modify the at least one rule for creating the subscriber segment; and
providing the client with a sample of subscriber population to be affected by one or more segments based on the at least one rule for creating the subscriber segment.

4. The method of claim 1, further comprising:
data mining subscriber information stored in one or more data stores for consistency and accuracy; and
authenticating and authorizing external data feeds prior to retrieval of the subscriber information.

5. The method of claim 1, further comprising:
if a subscriber is assigned to a plurality of segments, prioritizing the segments based on a selection from a client associated with the targeted content; and
observing the prioritization when enabling the provision of the retrieved targeted content to the application for rendering to the subscriber.

6. The method of claim 1, further comprising:
providing a documented interface for the profiling system such that a client associated with the targeted content is enabled to integrate a third party module to the profiling system for added functionality in one of: analyzing subscriber information, creating segments, and assigning subscribers to the created segments.

7. The method of claim 1, further comprising:
exchanging subscriber profile information with one or more partners for extending subscriber experience to the subscribers when they access websites of the one or more partners.

8. A profiling system for providing targeted content to subscribers of an online community, the system comprising:
a profiling data store configured to:
store subscriber specific information and subscriber segment configuration information; and
exchange information with at least one from a set of: a subscriber background information data store, a subscriber usage information data store, and a subscriber behavior information data store; and
at least one server configured to facilitate:
a profiling engine configured to:
data mine the information at the profiling data store for consistency and accuracy; and
transform the information at the profiling data store into subscriber profile in a consumable format;
a profiling studio configured to:
enable a client of the profiling system to create and customize one or more rules for defining subscriber segments; and
a profiling service configured to:
determine at least one subscriber segment for a subscriber based on subscriber location information, a subscriber profile for the subscriber, the defined subscriber segments;
enable retrieval of targeted content for the subscriber based on the at least one subscriber segment for the subscriber; and
enable provision of the retrieved targeted content to an application for rendering to the subscriber.

9. The system of claim 8, wherein the profiling studio includes:
a campaign console for enabling the client to create and customize the one or more rules and manage a marketing campaign involving the targeted content;
an administration console for assigning priorities to each of a plurality of subscriber segments assigned to one subscriber; and
a view console for providing the client feedback associated with subscriber information and a sample subscriber population to be affected by the created one or more rules.

10. The system of claim 8, wherein the profiling engine is further configured to:
compute page views for rendering the targeted content for a subscriber application; and
define data duration in the profiling data store.

11. The system of claim 8, wherein the targeted content includes at least one from a set of: a customized advertisement, an engagement message, and a customer relationship management communication.

12. The system of claim 8, wherein the profiling data store is further configured to store subscriber segment attribute information specifying a plurality of attributes for each subscriber segment and attribute configuration information specifying configurations of the plurality of attributes defining each subscriber segment.

13. The system of claim 8, wherein the subscriber information is updated periodically and subscriber assignments to subscriber segments are modified based on the updated subscriber information.

14. The system of claim 8, wherein the profiling system is extendable and scalable with documented user interfaces for enabling the client associated with the targeted content to integrate a third party module to the profiling system for added functionality in one of: analyzing subscriber information, creating segments, and assigning subscribers to the created segments.

15. The system of claim 8, wherein the profiling data store is further configured to dynamically synchronize subscriber specific information with at least one data store for storing demographic, psychographic, and behavioral subscriber information based on a client preference.

16. A computer-readable storage medium with instructions encoded thereon for providing targeted content to subscribers of an online marketplace through a profiling system, the instructions comprising:
receiving a subscriber identifier, a subscriber locale, a subscriber area, and a subscriber location associated with a subscriber;
retrieving subscriber information collected about the subscriber through at least one from a set of: sign-up to the online marketplace, log in to the online marketplace, usage of services at the online marketplace, and behavioral information based on the subscriber identifier;
receiving at least one rule for creating a subscriber segment from a client of the profiling system;
determining at least one subscriber segment for the subscriber based on the subscriber locale, the subscriber area, the subscriber location, the retrieved subscriber information, and the at least one rule for creating the subscriber segment;
enabling retrieval of targeted content for the subscriber based on the at least one subscriber segment for the subscriber;
computing page views for rendering the targeted content for a subscriber application; and
enabling provision of the retrieved targeted content to the subscriber application for rendering to the subscriber.

17. The computer-readable storage medium of claim 16, wherein the subscriber identifier includes at least one from a set of: an anonymous identifier and a subscription identifier, and wherein a cookie is used to keep track of the identifiers and subscriber assigned segments.

18. The computer-readable storage medium of claim 16, wherein the usage of services at the online marketplace includes at least one from a set of: subscriber purchases at the online marketplace, use of consumables at the online marketplace, electronic mail marketing messages, and keyword purchases for search engine marketing.

19. The computer-readable storage medium of claim 16, wherein the behavioral information is derived from tracking of the subscriber's page views by a third party reporting tool.

20. The computer-readable storage medium of claim 16, wherein the instructions further comprise:
retrieving updated subscriber information based on a client defined period; and
reassigning the subscriber to one or more relevant subscriber segments based on the updated subscriber information.
